(19) United States
(12) Patent Application Publication
(10) Pub. No.: US 2010/0288845 A1
(43) Pub. Date: Nov. 18, 2010

(54) Generation of Neutrally Buoyant Foam in a Gas

(76) Inventor: Imran Akbar, Tiburon, CA (US)

Correspondence Address: Imran Akbar, 216 Trinidad Drive, Tiburon, CA, 94920, US

(21) Appl. No.: 12/466,380

(22) Filed: May 14, 2009

(51) Int. Cl. A01G 25/09

(52) U.S. Cl. 239/1

(57) ABSTRACT

Generation of neutrally-buoyant foam utilizing a lighter-than-air gas. A handheld apparatus for generating and dispensing neutrally-buoyant foam, by mixing together a surfactant solution with a lighter-than-air gas. Methods of generating neutrally-buoyant foam, as well as foam that can solidify and eventually drift to the ground. Alternate embodiments provide a number of means for generating neutrally-buoyant foam, and for digitally recording shapes drawn.

### CROSS REFERENCE TO RELATED APPLICATIONS

None.

### FEDERALLY SPONSORED RESEARCH

None.

### SEQUENCE LISTING

None.

### FIELD OF THE INVENTION

The present invention is related to generating foam that is able to float in a gas while maintaining its shape and position over time.

### BACKGROUND OF THE INVENTION

For centuries, humans have been tools to express themselves by creating objects in two and three-dimensional (2D and 3D, respectively) space. The earliest and most primitive of these allowed cavemen to create drawings, and later tools such as the pen were integral to the development of written language and communication. Three-dimensional forms were harder to create, but more powerful in terms of the freedom of expression they granted; the earliest known form, still in use today, is clay. More recent examples of this type of solution include plasticine, play-doh, and Sculpy, along with construction toys such as Lego bricks and K'NEX and molding techniques like plaster of Paris. Once sharper tools were developed, one could also form 3D shapes by chiseling or cutting into large blocks of stone, wood, or ice.

There have been relatively recent attempts to extend such three-dimensional modeling to work in free space, i.e. the surrounding air. The main advantage in doing so is that it would not require the creation of a self-supporting structure, and thus would allow the creator maximum design flexibility. In addition, such additive methods tend to require much less starting material than, say, the use of clay or stone. The extant methods, are, however, inadequate for widespread adoption; three of them are in fact illusions. Painting with light captured by a camera with a slow shutter speed may produce a 2D picture of the path traced in 3D, but the 3D path drawn is not visible in the real world. The best example of this technique is the picture of a centaur drawn in the air with a flashlight by Pablo Picasso, as captured by photographer Gjon Milli in 1949. Similarly, one may use mechanical-articulated arms or wireless sensors with gyroscopes and accelerometers to electronically record a 3D path in the surrounding air, but the 3D shape is not physically created in free space. One of the only known methods of physically creating a shape in free space is skywriting, where an airplane's trajectory is varied to trace out a path in the sky with its exhaust fumes. However, skywriting has a number of drawbacks. It can only be done outdoors and at great altitude, is costly due to the need for an airplane and trained pilot, releases noxious smoke into the air, and quickly disperses the shape drawn due to the heat of the smoke and winds at altitude. More tractable alternatives such as flares still have respiratory health issues from smoke inhalation, and along with fog generators, still produce 3D forms that disperse rapidly and are not easily shaped. An alternative that was demonstrated by Glynn Golt of Boston University is that of acoustic levitation to keep foam floating in air, however this technique requires expensive equipment, fine control, a closed area, and will have a hard time maneuvering newly-created foam into the desired position.

The present invention seeks to overcome these issues and limitations by providing an apparatus and method for creating 3D shapes in a safe and convenient manner. The technique involves creating foams in the surrounding atmosphere (hereby referred to as airborne) that are able to maintain their shape (consistency) and position over short periods of time, of at least 30 seconds.

Foam is a colloidal dispersion of gas in liquid, in which gas bubbles are separated by water films called lamellae. Foams with a large amount of liquid in these water films have a high liquid or mass fraction (in colloquial, are ‘wet’) and are composed of spherical bubbles, while those bubbles with less liquid in between them assume a polyhedral shape. These lamellae and non-spherical bubbles are governed by Plateau's two laws, which dictate that only 3 lamellae can meet along an edge (forming an angle of 120 degrees) and only 4 edges can meet at a single point (meaning no more than four bubbles can be in direct contact with each other). Bubbles in foam always seek to minimize their effective surface area, which is affected by the surface tension of the film. Molecules known as surface-active agents, or surfactants, are utilized to decrease this surface tension and allow more bubbles to form. Commonly found in soaps and shampoos, surfactants/foaming agents (colloquially known as “foamers”) such as sodium lauryl sulfate are typically long-chain fatty acids or fatty alcohols. Surfactants begin to form clumps known as micelles once their concentration reaches a certain point, after which no more can be added. The higher the temperature of the surfactant, the more it will foam. Colors can be added to the bubbles by using chemicals such as phenolthalein or lactone ring dyes. When surfactants are mixed in with other liquids, a homogenous mixture defined as a solution or surfactant solution is formed.

Foams are found in a wide variety of contexts in nature and in manufactured goods. Foams occur naturally on beaches in the form of froth, and artificially in shaving cream, soap dispensers, beer, coffee, and carbonated soft drinks, fire extinguishers, cleaning products, foam machines, sprayed foam insulation, and food items such as whipped cream.

Foams can be created either by dispersion, in which gas is pulverized and mixed with the liquid, or condensation, in which the gas is dissolved in the liquid and then bubbles out. The latter technique is how foamy froth is formed in carbonated beverages, as the supersaturated carbon dioxide goes through nucleation once the external pressure decreases. The former method is exemplified when blowing/injecting gas into a liquid through small orifices, capillaries, gauze, a needle, nozzle, porous plug/plate (known as sparging), simultaneously flowing gas and liquid through a tube, or mechanically whipping/agitating the liquid in the presence of the gas.

A number of variables affect the type of foam produced. The size of bubbles produced is proportional to the gas flow rate, nozzle diameter, and the viscosity of the solution. The mixture ratio of gas to surfactant solution determines the expansion ratio of the foam, defined as the volume of foam produced divided by the volume of surfactant solution.

The apparatus used to generate the foam can vary in nature from aerosol cans to devices similar to airbrushes, atomizers, spray paints, spray guns, and foam nozzles, as well as more advanced and precise technologies such as micro-dispensers and microfluidic dispensers.

A frequent goal during foam production is that of creating monodisperse foam, that is, uniformly-shaped foam that is stable for longer periods of time. This is traditionally accomplished through the application of constant and low-pressure gas blown through a nozzle into the liquid.

Most foams are by nature thermodynamically unstable (lyophobic) and coarsen over time, eventually disintegrating as their bubbles rupture and dry out. The collapse of foam stems from three factors: diffusion of gas, bubble coalescence (film rupture), and draining of the liquid/film thinning. The diffusion of gas is dictated by Fick's law and the solubility of the gas in liquid, as foams with less soluble gases will coarsen more slowly. One of the ways foam collapse can be countered is to add glycerin to the solution, which increases its viscosity and slows evaporation by forming bonds with the water molecules.

In order to produce foam that maintains its position over time, fine control must be exerted over the buoyancy of the foam. Buoyancy is based on density, defined as mass divided by volume. In order to attain neutral buoyancy, the foam must have density in close approximation to that of the surrounding air, where the force of gravity is countered by buoyancy. Air density is affected by variables including temperature, altitude, and humidity in the air; due to Avogadro's law, the buoyancy force of a gas is solely determined by its molecular weight—which leads to hydrogen, helium, ammonia, and methane, among others, being lighter-than-air. The buoyancy force of a bubble is proportional to the volume of the bubble, and inversely proportional to the thickness of its film.

Thus, by exerting control over the volume and thickness of a foam's bubbles, one should be able to attain neutrally-buoyant foam. Foams infused with methane and helium have been recently created that are able to float up into the air, but none have been demonstrated that manage to stay in place.

### SUMMARY OF THE INVENTION

Embodiments provide means with which to generate and dispense neutrally-buoyant foam into a gaseous medium. In the preferred embodiment, a lighter-than-air gas is mixed with a surfactant solution and blown through a mesh screen to generate foam. Additional options allow for the production of colored foam, foam that gradually solidifies and floats to the ground, and the electronic recording of shapes drawn in 3D space.

The features and advantages described in the specification are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

Embodiments of the present invention can be readily understood by considering the following detailed description in conjunction with the accompanying drawings.

FIG. 1 is a cross-section from a side orthogonal view illustrating the preferred embodiment of the invention.

FIG. 2 is a cross-section from a side orthogonal view illustrating an alternate embodiment of the invention which utilizes a Venturi pump.

FIG. 3 is a cross-section from a side orthogonal view illustrating an alternate embodiment of the invention which uses external gas and solution sources.

FIG. 4 is a cross-section from a side orthogonal view illustrating an alternate embodiment of the invention which makes use of a fan.

FIG. 5 is a cross-section from a side orthogonal view illustrating an alternate embodiment of the invention that employs a mixer.

FIG. 6 is a cross-section from a side orthogonal view illustrating an alternate embodiment of the invention that includes a micro fluidic tube.

FIG. 7 is a cross-section from a side orthogonal view illustrating an alternate embodiment of the invention which contains a porous membrane.

FIG. 8 is a flow chart illustrating the sequential steps of a foam production technique employed in the invention.

### DETAILED DESCRIPTION OF THE INVENTION

A preferred embodiment of the present invention is now described with reference to the figures where like reference numbers indicate identical or functionally-similar elements.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

Certain aspects of the present invention include process steps and instructions described herein in the form of an algorithm. It should be noted that the process steps and instructions of the present invention could be embodied in software, firmware, or hardware, and when embodied in software, could be downloaded to reside on and be operated from different apparatuses used by a variety of operating systems.

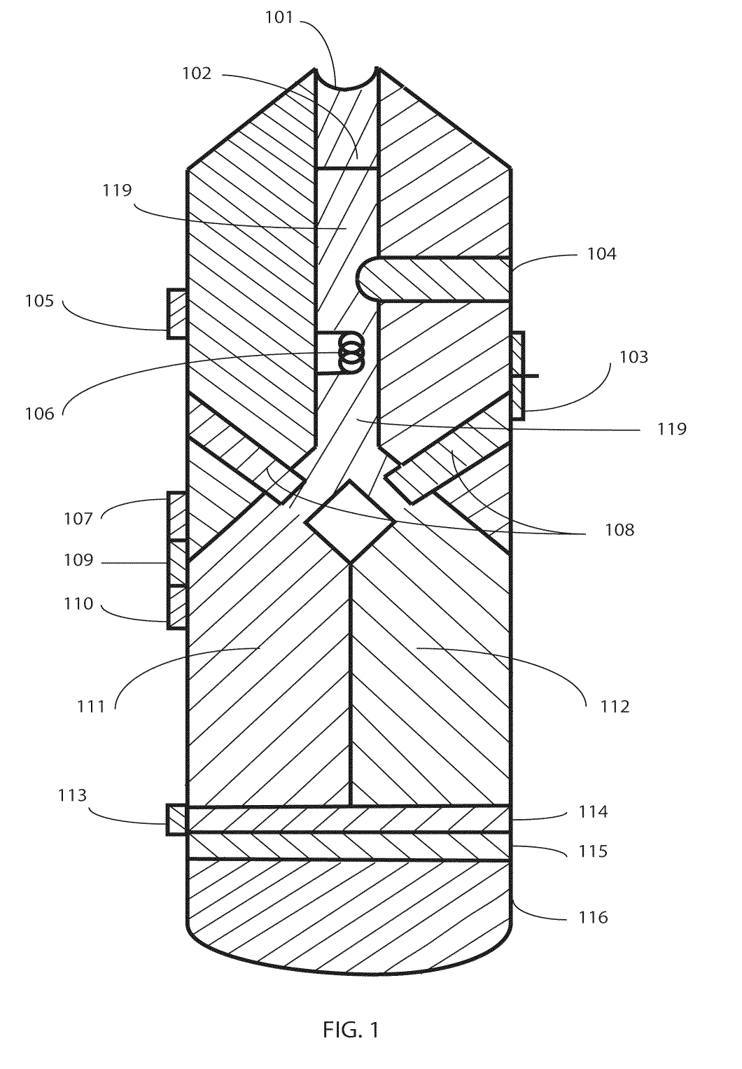

### Detailed Description—FIG. 1—First Embodiment

One embodiment of the invention is illustrated in FIG. 1; the shape is a cross-section from a side orthogonal view of the device in which its inner components can be seen. The entire apparatus in its preferred embodiment is small enough to be grasped by a human hand, so should not exceed twelve inches in length, and two inches in diameter. The main components include two replaceable tanks holding a surfactant solution 112 and a lighter-than-air gas 111. These tanks connect to a chamber 119 that is flanked by flow-control valves 108, which may be solenoid valves, ball valves, one-way valves, etc. Further down the chamber 119 is an electric heating coil 106 and a color injector 104 which may be similar to an inkjet printer cartridge or spray. The chamber then intersects with a mesh screen/gauze/cloth/net 102 that passes through the tube, which then continues until it reaches a nozzle covered by a variable-aperture shutter 101. The apparatus may optionally include a location/position sensor 115 which may take the form of a Global Positioning System (GPS), an inertial measurement system using gyroscopes and accelerometers, ultrasonic sensors, radio frequency sensors, or others, likely in combination with an antenna 113. A microcontroller circuit 115 is connected to the rest of the electronic components of the apparatus, and a battery pack 116. The outside surface of the device includes a number of digital sensors, including a temperature sensor 107, a pressure sensor 109, and humidity sensor 110. In addition, there are two operator controls, including a push button 105 and a color-control slider 103. An additional option modifies the surfactant solution in the tank 112 to a solution with ultraviolet-light curable/activated resins or epoxies, in order to gradually harden the foam so it may solidify as it floats down to the ground, eventually forming a solid structure.

### Operation—FIG. 1

The device serves to produce and dispense foam that can achieve neutral buoyancy. The process starts when the operator pushes down the button 105, which sends power from the battery 116 to power up the microcontroller 115, which polls the sensors 107, 109, and 110, the data from which is used to automatically calibrate the device to produce the optimal foam to obtain neutral buoyancy in the surrounding atmosphere. The microcontroller 115 then releases fluids from the tanks of surfactant solution 112 and lighter-than-air gas 111 as controlled by the flow-control valves 108, which open and close to exert precise control over the flow rate, pressure, and mixing ratio of the two fluids. As the fluids pass through the chamber 119 the heating coil 106 may be activated to increase the temperature of the mixture. If a particular color of foam is desired, the operator would use the color slider control 103 on the device to signal the color injector 104 to impart a color into the mixture as it passes. As the fluid mixture passes through the mesh screen 102 the gas forms bubbles in the solution, and foam results. The foam proceeds to the nozzle where a shutter 101 with a variable aperture controls the output of the foam. The position/location sensor 113 may be engaged to record the movements of the device over time to keep a digital record of the shape drawn, for transmission to a computer over the antenna 115, or for storage locally.

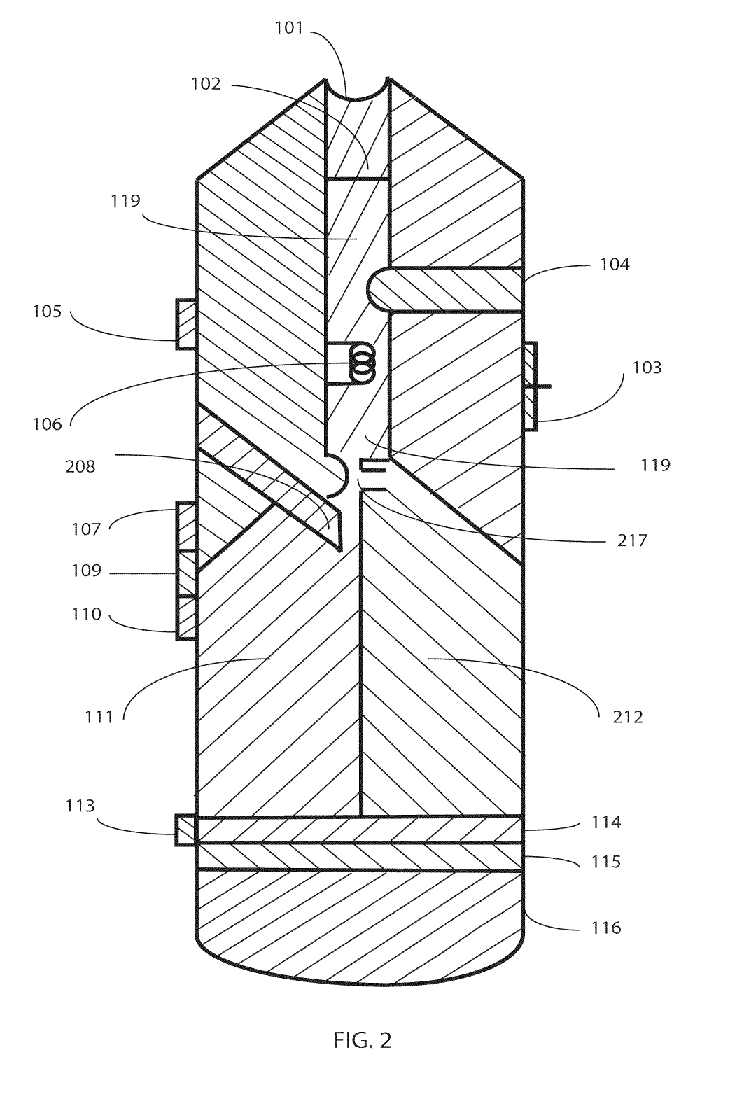

### Detailed Description—FIG. 2—Alternate Embodiment

This alternate embodiment features an unpressurized surfactant solution tank 212, and a narrow section of the chamber that forms a Venturi pump 217, along with a flow-control valve 208; the remaining parts in this figure are identical to FIG. 1.

### Operation—FIG 2.

When the flow-control valve 208 is opened, pressurized gas is sent through the Venturi pump 217 creates an area of low pressure which provides a suction force (due to Bernoulli's equations) to lift surfactant solution from the tank below 212, and mix with the gas. The advantage of this approach is that it does not require the solution to be pressurized.

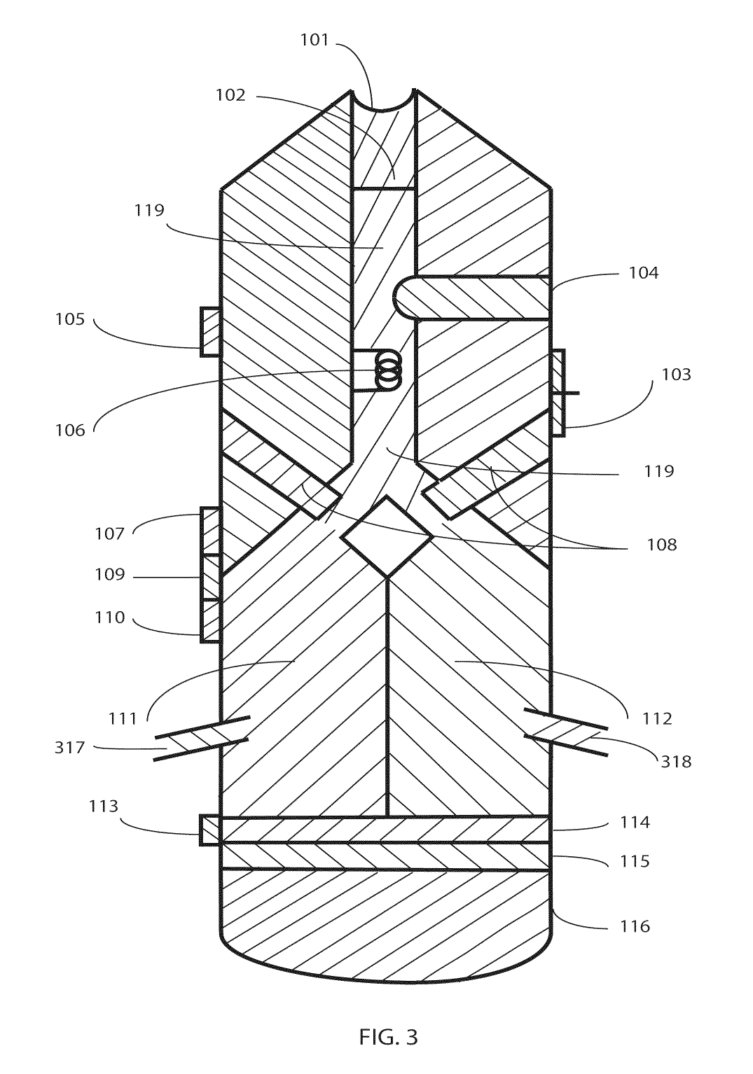

### Detailed Description—FIG. 3—Alternate Embodiment

This alternate embodiment includes two additional tubes, 317 and 318, one for each of the gas and surfactant solution tanks, that connect to the inside of the tanks and lead away from the device; the remaining parts in this figure are identical to FIG. 1.

### Operation—FIG 3.

The tubes 317 and 318 allow for the two components, the gas and the surfactant solution, to be kept externally and only pumped in when needed through the respective pipes.

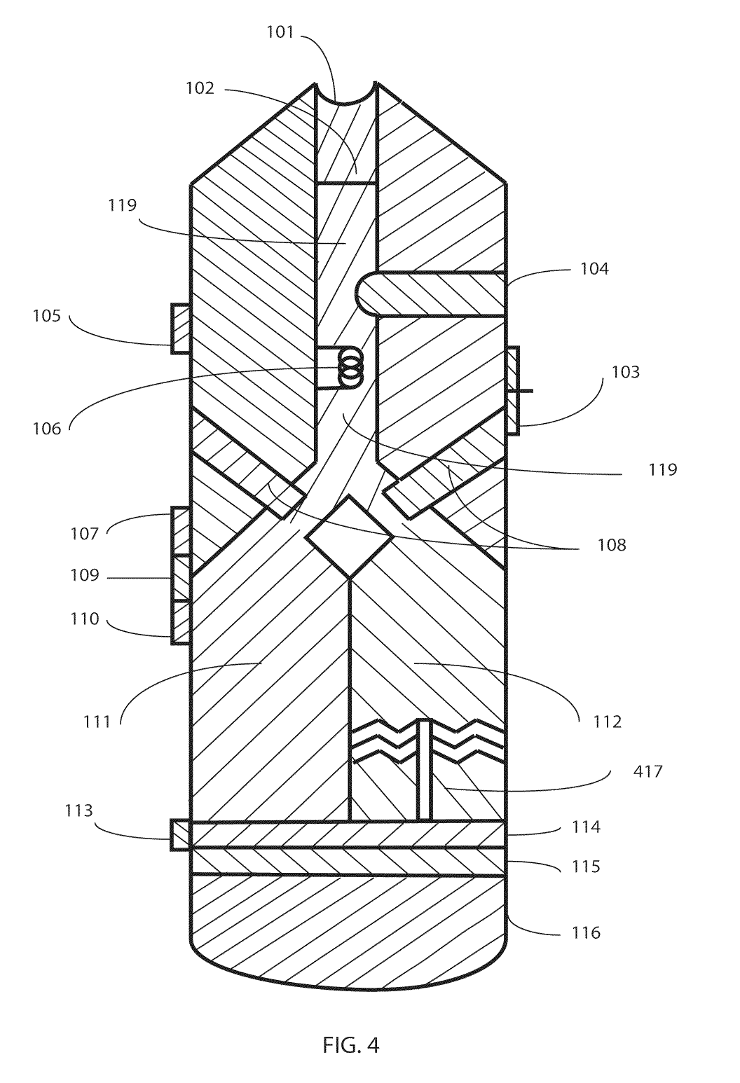

### Detailed Description—FIG. 4—Alternate Embodiment

This embodiment additionally includes a fan 417 located inside the tank holding the surfactant solution; the remaining parts in this figure are identical to FIG. 1.

### Operation—FIG 4.

The fan 417 allows the device to eject surfactant solution from the tank in order to mix with the gas to form foam. One advantage of this is that the tank need not be pressurized.

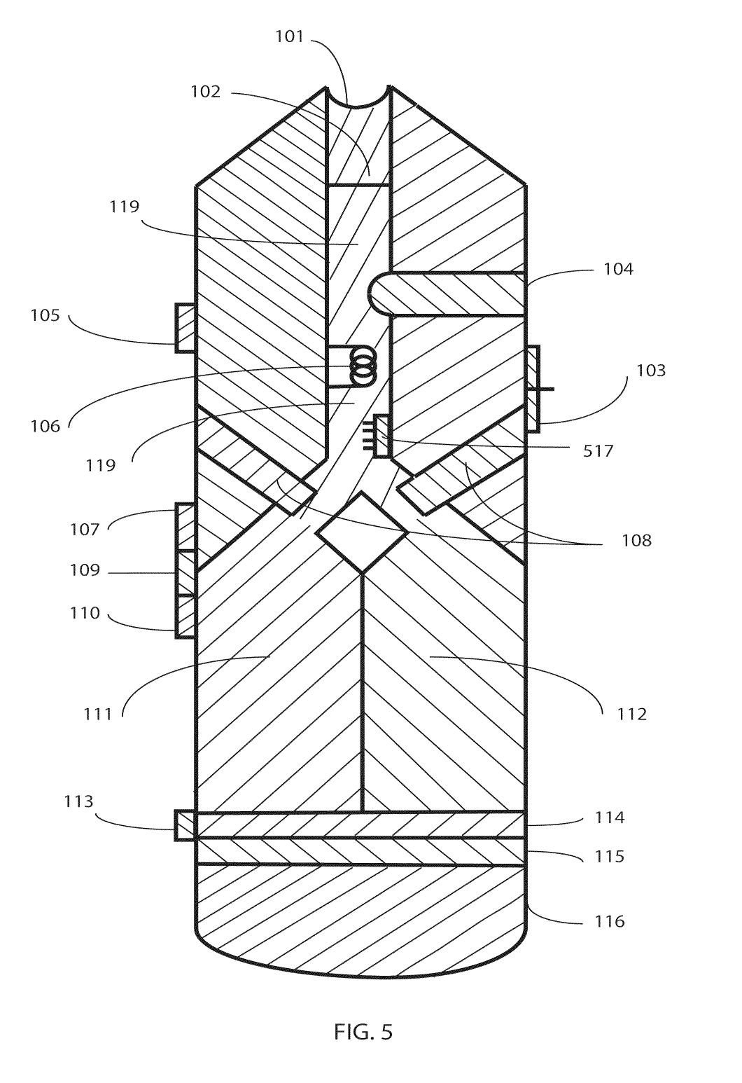

### Detailed Description—FIG. 5—Alternate Embodiment

This embodiment includes a component such as a whip, brush, ultrasonic atomizer, or piezoelectric actuator 517; the remaining parts in this figure are identical to FIG. 1.

### Operation—FIG 5.

The component 517 in the chamber of the tube is used to mix the gas and solution fluids together.

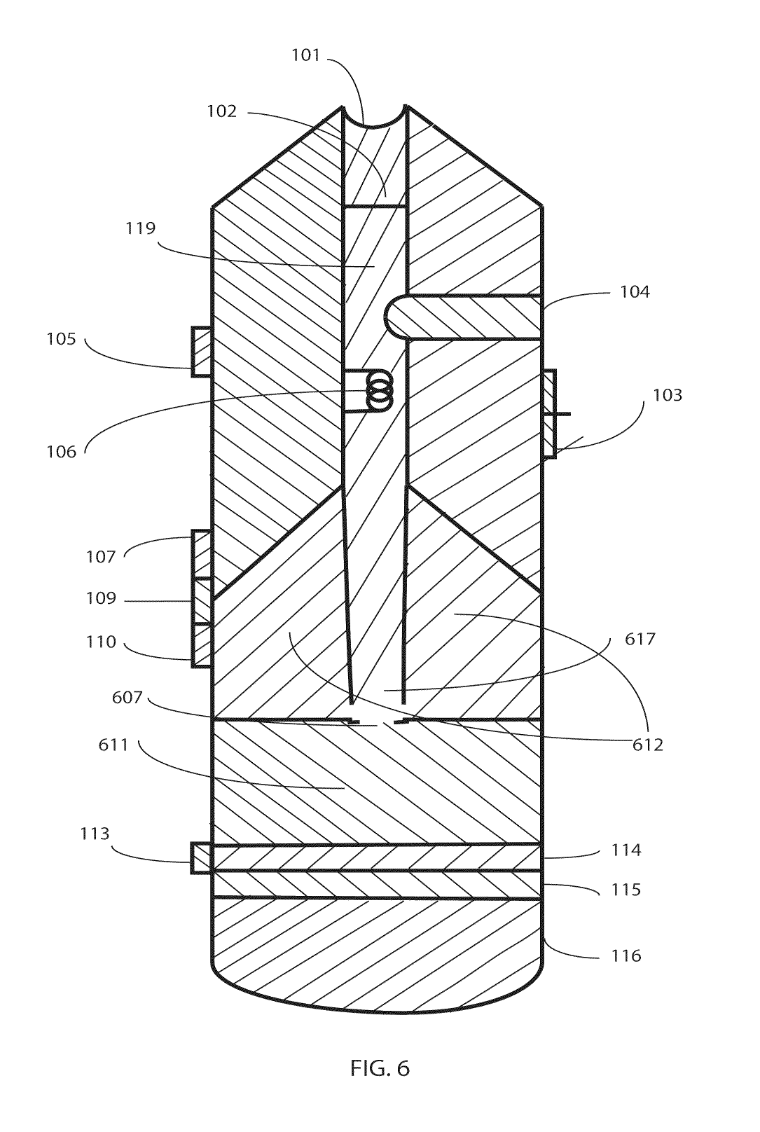

### Detailed Description—FIG. 6—Alternate Embodiment

This embodiment includes a micro fluidic flow-focusing capillary tube 617, a flow-control valve 607, a chamber of gas 611, and a chamber of surfactant solution 612; the remaining parts in this figure are identical to FIG. 1.

### Operation—FIG 6.

The capillary tube 617 creates a channel for the gas in the chamber 611 to escape through the opening controlled by the flow-control valve 607, pass through a thin film of surfactant solution in the chamber 612 before forming bubbles in the tube. The advantage of this embodiment is that it allows finer control over the foam produced.

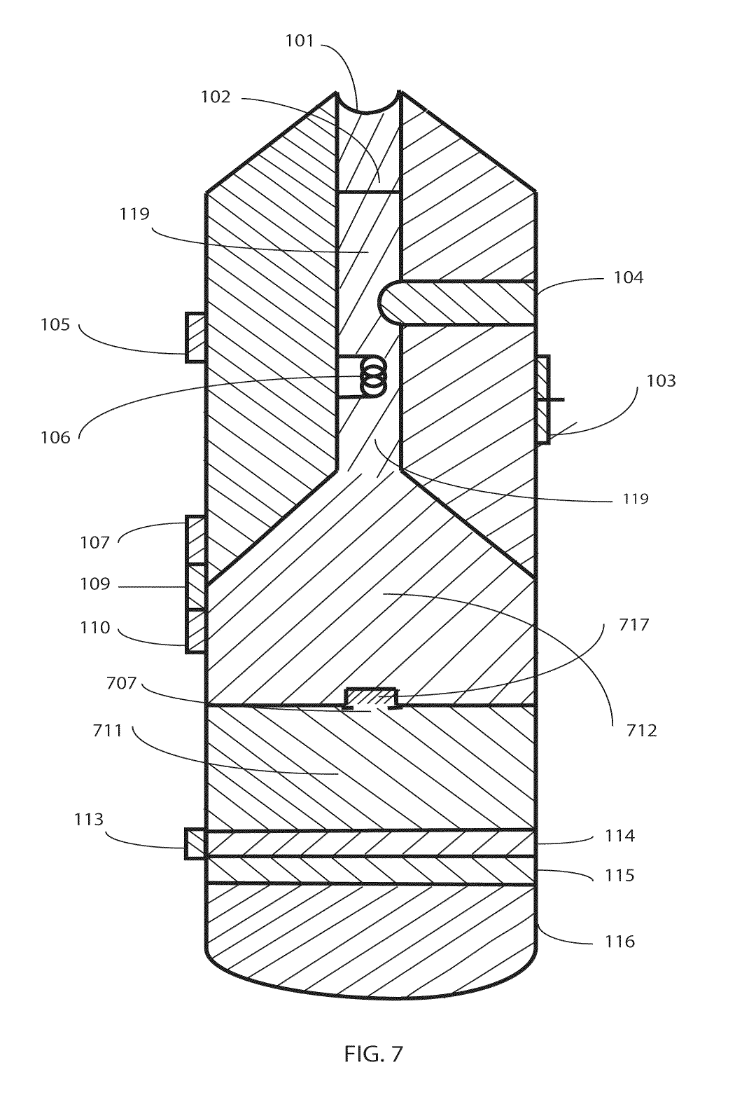

### Detailed Description—FIG. 7—Alternate Embodiment This embodiment includes a porous plug 717 located in front of a solenoid valve 707 between the gas 711 and surfactant solution 712 chambers; the remaining parts in this figure are identical to FIG. 1.

### Operation—FIG 7.

The porous plug 717 serves to create small bubbles when gas is released by the flow-control valve 707, as gas travels through the small pores of the porous plug from the gas chamber 711 and enters into the surfactant solution chamber 712.

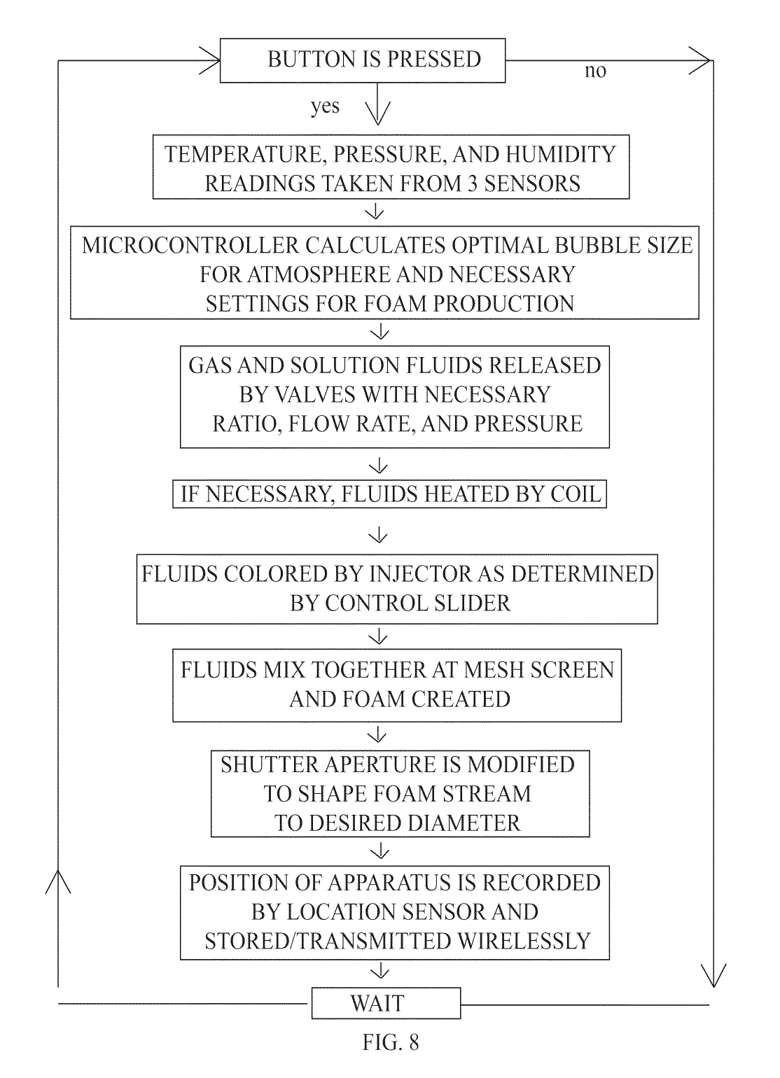

### Detailed Description—FIG. 8—Flowchart of Foam Production Loop

FIG. 8 illustrates the steps involved in the production of foam using the invention. Once the operator depresses the button, the button makes electrical contact with a wire, completing a circuit which powers on the microcontroller. The microcontroller then proceeds to poll the three digital atmospheric condition sensors for pressure, temperature, and humidity readings. These are used as input to a heuristic or algorithm calculated by the microcontroller to determine the optimal settings necessary to produce neutrally buoyant foam under the current conditions. The next step is to direct the valves at the end of the tanks of gas and surfactant solution to open just wide enough, and for a long enough duration, to release the fluids in the correct ratio and with the right pressure and flow rate to achieve the desired consistency. As the mixture of fluid passes through the chamber, it encounters a heating coil which is activated when it's necessary to heat up the mixture. Then the mixture passes past the color injector which sprays droplets of a dye or chemical as specified by the color slider control. Once the mixture reaches the mesh screen, the small aperture of the mesh forces the liquid and gas to mix together, with foam being ejected from the other side. This foam travels through the shutter, which is opened to the desired diameter. Finally, an optional location tracker may be engaged to record the position of the apparatus in 3D space for transmission to a computer, for example, or storage.

Although the present invention has been described above with respect to several embodiments, various modifications can be made within the scope of the present invention. Accordingly, the disclosure of the present invention is intended to be illustrative, but not limiting, of the scope of the invention, which is set forth in the following claims.

What is claimed is:

1. Generation of neutrally-buoyant foam composed of helium gas.

2. An apparatus for generating neutrally-buoyant foam composed of helium gas, whereby an operator may draw a shape in free space.

3. The apparatus of claim 2 wherein said apparatus is small enough to be operated with one human hand.

4. The apparatus of claim 2, further including a microcontroller and sensors, such as temperature, pressure, and humidity sensors, whereby said foam can be produced with the correct properties in order to ensure neutral buoyancy in the atmosphere.

5. The apparatus of claim 2, further including a wireless position tracking system, whereby a digital copy of the path drawn in free space may be recorded.

6. The apparatus of claim 2, further including a pressurized gas, whereby a large volume of said foam may be produced from a small volume of gas.

7. The apparatus of claim 2, further including a pump, whereby a surfactant solution may be utilized at varying pressures and flow rates to generate said foam with the correct properties in order to ensure neutral buoyancy in the atmosphere.

8. The apparatus of claim 2, further including a micro fluidic flow focusing device, whereby monodisperse bubbles may be generated to aid the stability of said foam.

9. The apparatus of claim 2, further including compartments for holding a lighter-than-air gas and a surfactant solution, whereby the fluids contained in the compartments may be mixed to generate said foam.

10. The apparatus of claim 2, further including a heater, whereby a mixture of fluids may be set to the correct temperature necessary for achieving neutral buoyancy in the atmosphere.

11. The apparatus of claim 2, further including a color injector, whereby said foam may be colored.

12. The apparatus of claim 2, further including a porous membrane, whereby a gas may be bubbled into a surfactant solution to generate said foam.

13. Method of generating neutrally-buoyant foam by mixing helium gas with a liquid solution.

14. The method of claim 11 wherein said foam is composed of monodisperse bubbles, whereby more stable foams may be generated.

15. The method of claim 11 wherein said foam is designed to gradually solidify on exposure to the atmosphere and descend to the ground, whereby a permanent copy of the shape drawn in free space is retained.

16. The method of claim 11 wherein said gas and solution are passed through a mesh screen, whereby said foam may be generated.

17. The method of claim 11 wherein said gas and solution are mixed using a Venturi pump, whereby said foam may be generated.

18. The method of claim 11 wherein said foam is produced through dispersion.

19. The method of claim 11 wherein said foam is produced through condensation.

20. The method of claim 11 wherein said liquid solution contains a surface active agent.
